(19) United States
(12) Patent Application Publication
(10) Pub. No.: US 2008/0180477 A1
(43) Pub. Date: Jul. 31, 2008

(54) IDENTIFICATION OF CHARACTERISTICS OF MEDIA USED IN A PRINTER APPARATUS

(76) Inventor: Donald C. Trombley, Rochester, NY (US)

Correspondence Address: David A. Novais;Patent Legal Staff, Eastman Kodak Company, 343 State Street, Rochester, NY, 14650-2201, US

(21) Appl. No.: 11/669,410

(22) Filed: Jan. 31, 2007

(51) Int. Cl. B41J 29/38

(52) U.S. Cl. 347/16

(57) ABSTRACT

A media assembly and printer media supply are provided that enable automatic determination of a predetermined parameter value of a strip of media material are disclosed. The media assembly includes a cylindrical core upon which a strip of the media material is spirally wound. The core has an end into which at least one notch is recessed such that the notch has a physical characteristic indicative of the predetermined parameter value of the wound strip. The assembly further includes a flange on the core end wherein the flange is adapted to detect the physical characteristic of the notch and to adapt a tactile feature that represents the parameter value of the wound strip. The printer media supply allows automatic detection of the feature and determination of the predetermined parameter value based upon the detected feature.

### FIELD OF THE INVENTION

The present invention relates to a printing apparatus capable of forming an image on a receiver material and, more specifically, to such a printing apparatus having the ability to detect one or more predetermined parameters of the inserted media.

### BACKGROUND OF THE INVENTION

It is well known to provide web media that is wound on a core for insertion into a web-feeding mechanism of a printer. As used herein, the term “core” is intended to include flanged cores, otherwise known as “spools.” Such media may be receiver material that may be cut into sheets before or after printing, ink or dye ribbons wherein marking material is transferred to a receiver, intermediate transfer webs, etc. The web media may or may not be housed in a cartridge.

The media may have different predetermined parameters, such as the receiver material surface gloss, thickness, age, grain direction, manufacturer's identity, density, speed, and other variables that can be used to optimize the performance of the printing apparatus. For example, some receiver materials may be best suited for multicolor printing or monochrome printing. Ink and dye ribbons may be one of a plurality of colors needed by the printing apparatus. In laser thermal printer apparatus, whether transferring colorant directly to a receiver material or first to an intermediate receiver, a key parameter is colorant density. Similarly, an inkjet printer apparatus or an electrophotographic printer apparatus can be adjusted so as to vary the amount of colorant applied or by adjusting operational variables such as drying time or fusing temperature and speed. Information may be identified to the printing apparatus relating to a predetermined parameter or parameters so that the printing operation is controllably performed on the basis of the identified information.

In some types of printer apparatus, an operator may be able to make some type of adjustment based on the media to be used, such as varying colorant quantity, drying time, fusing time, fusing temperature, etc. However, correctly making this type of manual adjustment requires a high level of skill and judgment on the part of the printer operator, thereby increasing risk of operator error. Often, such information may be identified from the media to the printing apparatus via a mark associated with the media that is characteristic of a variable parameter. The mark is generally detected by a sensor that is disposed within the printing apparatus. Conventionally, the information mark is recorded on the web itself, on the cartridge, or on a core upon which the web is wound. See, for example, U.S. Pat. No. 5,385,416 to Maekawa et al., issued Jan. 31, 1995, entitled “Device for Identifying an Ink Ribbon Cartridge Used in a Printer”. In commonly assigned U.S. Pat. No. 5,455,617 to Stephenson et al., issued Oct. 3, 1995, entitled “Thermal Printer Supply Having Non-Volatile Memory,” an electronically operable memory is mounted on a media material core for storing data corresponding to data indicative of actions to be taken by a printer apparatus to adjust the color of a printed image.

### SUMMARY OF THE INVENTION

Accordingly, it is a feature of the present invention to provide an apparatus wherein an elongated strip of media material having a parameter with a predetermined value is wound upon a cylindrical core having an end into which at least one notch is recessed such that the notch has a physical characteristic indicative of the predetermined parameter value of the wound strip.

It is another feature of the present invention to provide a media assembly for identifying a predetermined parameter value of a strip of media material wherein the media assembly includes a cylindrical core upon which a strip of the media material is spirally wound. The core has an end into which at least one notch is recessed such that the notch has a physical characteristic indicative of the predetermined parameter value of the wound strip. The assembly further includes a flange on the core end wherein the flange is adapted to detect the physical characteristic of the notch and to adapt a tactile feature that represents the parameter value of the wound strip.

In yet another feature of the present invention, a media supply system for a printer is provided. The media supply system comprises: a paper tray area adapted to receive a media assembly having a cylindrical core upon which a strip of a media material is spirally wound, the core having an end into which at least one notch is recessed such that the notch has a physical characteristic indicative of the predetermined parameter value of the wound strip; and a flange on the core end adapted to detect the physical characteristic of the notch and to adapt a tactile feature that represents the parameter value of the wound strip; a sensor positioned proximate to the flange on the core end, said sensor being adapted to sense any adaptation of the tactile feature and to generate a sensor signal indicative of the current state of the tactile feature; and a control circuit connected to the sensor and adapted to receive the sensor signal and to determine a parameter value of the wound strip based upon the sensor signal.

In accordance with one embodiment of the present invention, the physical characteristic of the notch is its axial depth, and the flange includes a captured member that is urged into the notch. The flange includes a captured member that is urged into the notch; and the captured member has an element associated with the member so as to extend from the flange a distance inversely proportional to the depth of the notch so as to provide a detectable tactile feature that represents the parameter value of the wound strip.

### BRIEF DESCRIPTION OF THE DRAWINGS

FIG. 1 is a schematic perspective view of a media assembly according to the present invention;

FIG. 2 is a schematic perspective view of the front of a thermal printer that can be employed to make images on a receiver material in accordance with the present invention;

FIG. 3 is a schematic perspective rear view of the printer of FIG. 2;

FIGS. 4-6 are a series of schematic perspective views of the media assembly of FIG. 1 being loaded into the printer of FIGS. 2 and 3;

FIG. 7 is a perspective exploded view of the outer side of a flange according to a preferred embodiment of the present invention;

FIG. 8 is a perspective exploded view of the inner side of the flange of FIG. 7;

FIG. 9 is a perspective assembly view of the inner of the flange of FIGS. 7 and 8;

FIG. 10 is a perspective view of a core for a wound strip of media material; and

FIG. 11A shows a schematic cross-section view of media assembly loaded into one embodiment of a media supply system taken along a plane extending between a first notch pair.

FIG. 11B shows a schematic cross-section view of media assembly loaded into the embodiment of media supply system shown in FIG. 11A but taken along an axis extending between a second notch pair.

FIG. 12 is a perspective exploded view of a media assembly according to a second embodiment of the present invention in a first state;

FIG. 13 is an end view of a core according to the embodiment of FIG. 12 in a second state; and

FIG. 14 is an end view of a core according to the embodiment of FIG. 12 in a third state.

### DETAILED DESCRIPTION OF THE INVENTION

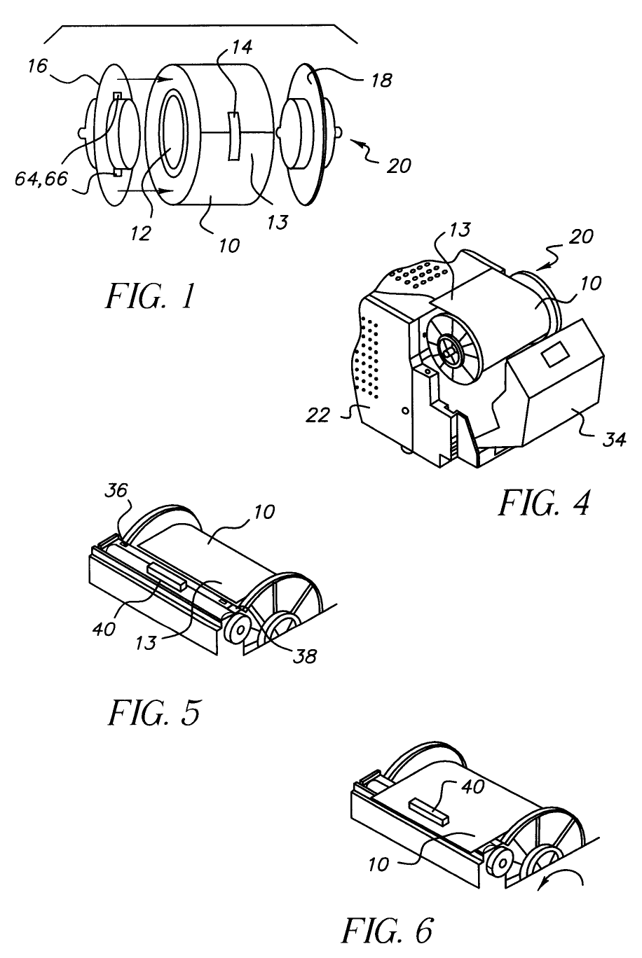

FIG. 1 shows a media material strip 10 of media material wound on a cylindrical core 12. As shown in FIG. 1, a loose end 13 of the media material strip 10 is secured by a tape 14 or other conventional mechanisms during shipping, storage or other processing. A pair of end flanges 16 and 18 fit into core 12, as will be fully explained below. Media material strip 10, the core 12, and the two end flanges 16 and 18 form a first embodiment of a media assembly generally referred to by reference numeral 20. In this embodiment, the media material will be described as a thermal paper upon which a thermal printer apparatus records images.

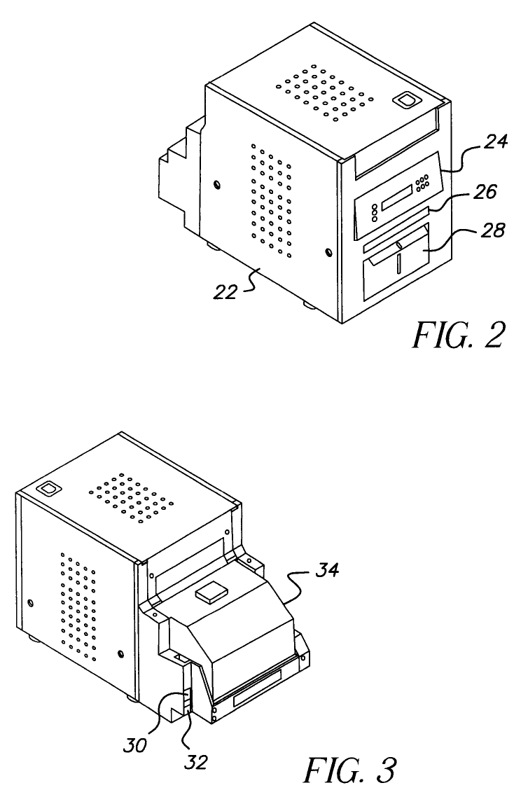

FIG. 2 shows one possible embodiment of a roll feed thermal printer apparatus 22 that is suitable for use with the present invention. It will be understood that the illustrated embodiment of a thermal printer is but one type of printer apparatus 22 that may incorporate the features of the present invention.

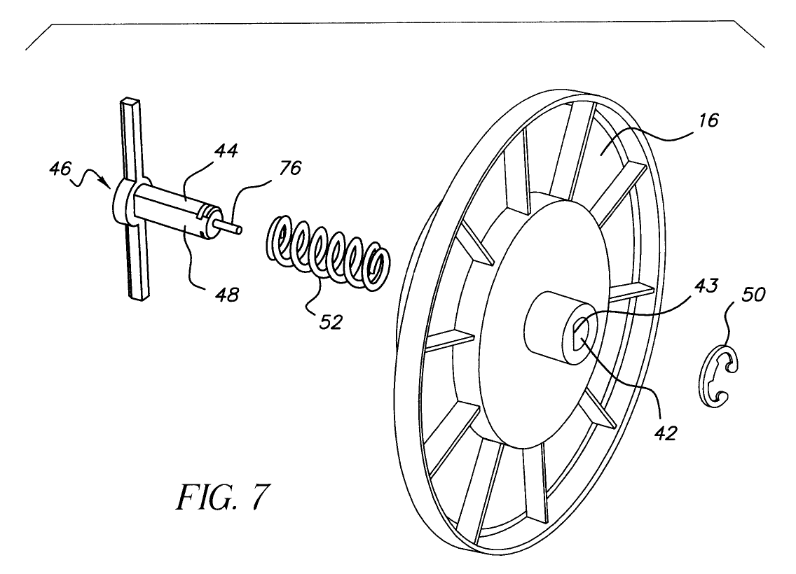

The front of printer apparatus 22 has an operator interface panel 24, a print exit slot 26 and an openable tray 28. Referring to FIG. 3, the rear of printer apparatus 22 includes a power switch 30, a power connector 32, and a paper door 34. FIG. 4 shows paper door 34 open to reveal portions of a media supply system 35 having media assembly 20 inserted. Once media assembly 20 is inserted, loose end 13 of media material strip 10 is aligned with a pair of alignment marks 36 and 38, shown in FIG. 5 and fed under a pinch roller 40 as illustrated in FIG. 6.

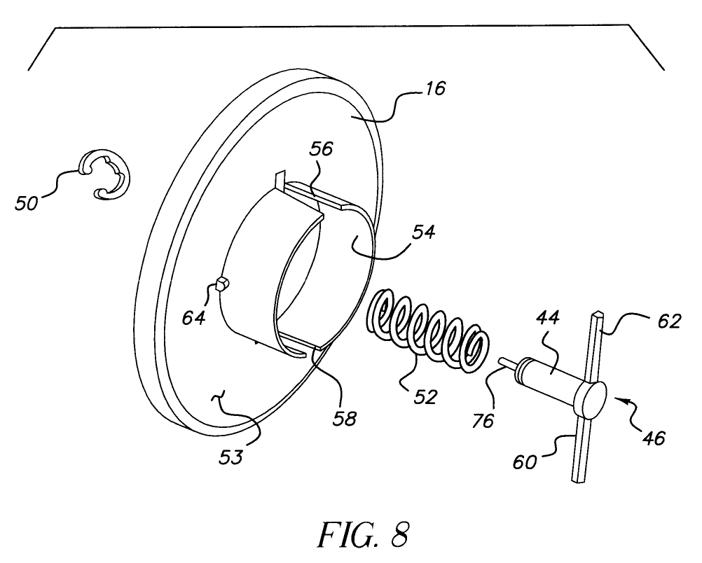

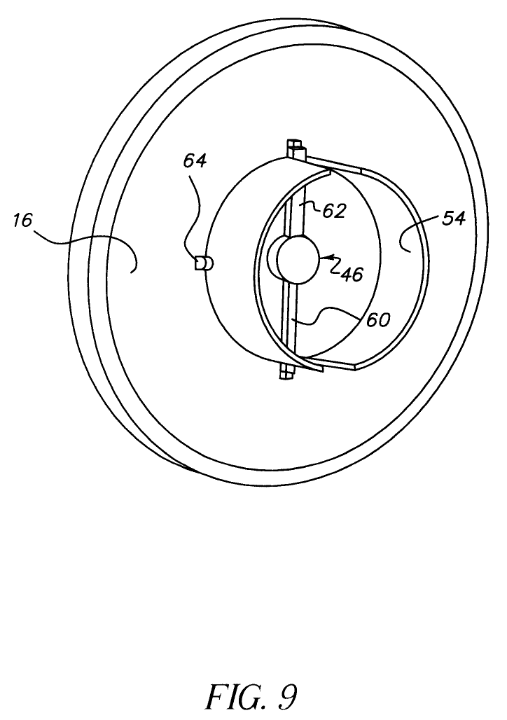

FIGS. 7 and 8 illustrate the opposed sides of flange 16. Flange 16 has a central bore 42 through which a shaft 44 of a T-bar 46 is threaded. The central bore 42 of flange 16 has a flat surface 43 against which a flat 48 of shaft 44 sits so that the T-bar 46 does not turn relative to flange 16. Once mounted in central bore 42, T-bar 46 is captured by a snap C-ring 50 against the bias of a spring 52. An inner surface 53 of flange 16 has an annular collar 54 with a pair of opposed slots 56 and 58. Slots 56 and 58 align with arms 60 and 62 of T-bar 46 so that T-bar 46 can be moved against the bias force of spring 52 into central bore 42 as shown in FIG. 9. One locating tab 64 is illustrated on the outer surface of collar 54 at its base. A second locating tab 66, as shown in FIG. 1, opposes lugs 64 180° around collar 54.

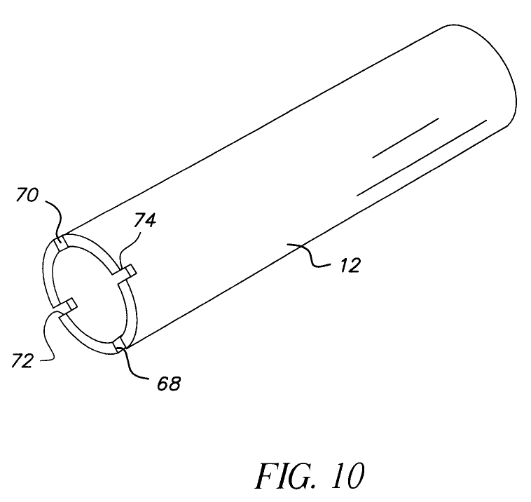

FIG. 10 illustrates core 12 upon which a media material strip 10 is wound (see FIG. 1). Core 12 has a first pair of opposed notches 68 and 70 and a second pair of opposed notches 72 and 74. Notches 68 and 70 align with locating tabs 64 and 66 when flange 16 is mounted on the end of core 12.

In this embodiment, first pair of opposed notches 68 and 70 and second pair of opposed notches 72 and 74 are cut during manufacture to a depth that is a function of one type of media material that can be wound on core 12. For example, core 12 can have first notch pair 68 and 70 that are cut to a depth of, for example and without limitation, 10 cm for media having a sensitivity of “x” while second notch pair 72 and 74 can be cut to a depth of, for example, 5 cm for media having a sensitivity of “y”.

In operation, the ends of T-bar 46 can be located within a selected one of first notch pair 68 and 70 or second notch pair 72 and 74 when flange 16 is mounted on the end of core 12. Since T-bar 46 can move in or out of flange 16, and is biased inwardly by spring 52, arms 60 and 62 of T-bar 46 will drop into the selected notch pair until they bottom out at the bottom of the notches. T-bar 46 is also connected to and controls the position of a post 76 relative to flange 16 through which post 76 extends. In another example, only one notch pair is provided with discrimination between different types of media being made possible based upon whether arms 60 and 62 of T-bar 46 are positioned within the provided notch pair or not. It will be appreciated that the distance that post 76 extends beyond flange 16 is inversely proportional to the depth of first notch pair 68 and 70, second notch pair 72 and 74, and any other notch pairs formed on core 12. As such, it will also be appreciated that discrimination between two different types of media can be made based upon which notch pair the arms 60 and 62 of T-Bar 46 are located. Further, it will be appreciated that where, flange 16 is joined to core 12 such that arms 60 and 62 of T-bar 46 are not located in a notch pair, post 76 will extend from flange 16 by a maximal distance, permitting a further point of discrimination between at least two types of media.

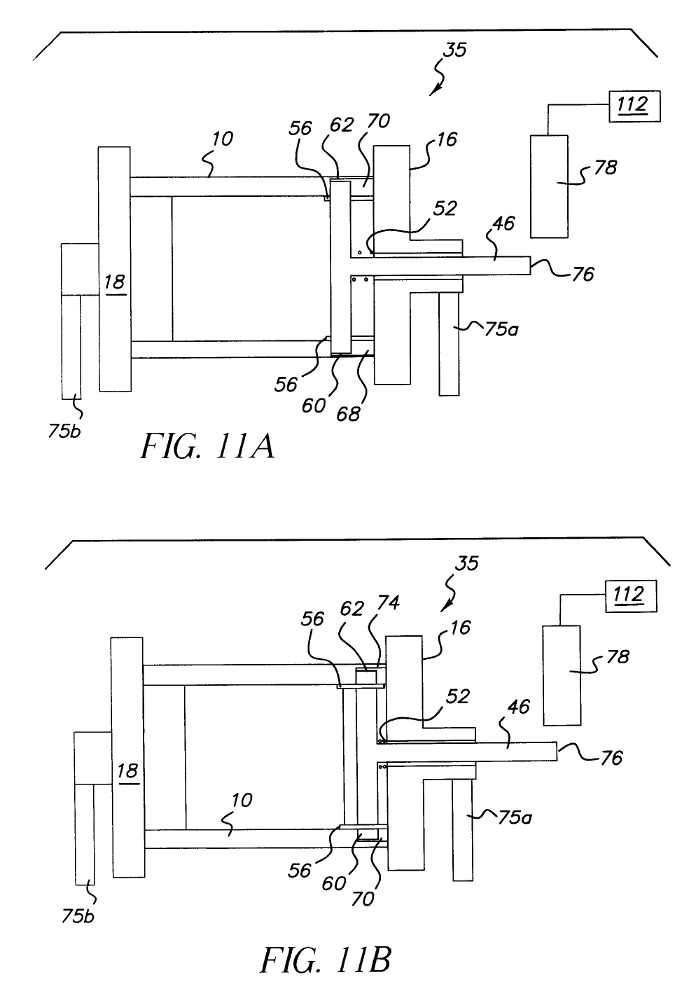

An example of the use of a first notch pair 68 and 70 and a second notch pair 72 and 74 to provide such discriminates is illustrated in greater detail in FIGS. 11A and 11B. FIG. 11A shows a schematic cross section view of media assembly 20 loaded into one embodiment of a media supply system 35 taken along a plane extending between notches 68 and 70. FIG. 11B shows a schematic cross section view of media assembly 20 loaded into the embodiment of media supply system 35 shown in FIG. 11A but taken along an axis extending between notches 72 and 74. In this embodiment, media supply system 35 is adapted with bearing surfaces 75a and 75b to receive and to position media assembly 20 so that it can supply media for printing as discussed generally above. As is illustrated in FIG. 11A, when arms 60 and 62 of T-bar 46 drop into first notch pair 68 and 70 a post 76 at an outer end of T-bar 46 that extends axially to a first position relative to flange 16. As is illustrated in FIG. 11B, when the ends of T-bar 46 drop into notch pair 72 and 74, post 76 extends axially to a second position beyond the position of post 76 when the ends of T-bar 46 are within first notch pair 68 and 70.

A sensor 78 in printer media supply 35 is adapted to detect a position of post 76 and to produce a signal indicative of the whether post 76 extends beyond flange 16 by a predetermined extent. In one embodiment, detection can involve determining the actual or relative distance that post 76 extends beyond flange 16. In another embodiment, such detection can comprise detecting whether post 76 extends axially by one or more predetermined distances from flange 16. In accordance with one embodiment of the invention, sensor 78 can be an optical interrupter switch such as Fairchild Semiconductor's Optologic model QVE00112 switch. Other apparatii and methods for sensing whether that post 76 extends beyond flange 16 by a predetermined extent will readily occur to persons of ordinary skill in the art.

It will be apparent that the distance that post 76 extends beyond flange 16 provides a detectable tactile feature that is indicative of the particular media material strip 10 wound on core 12.

In application within a printer media supply 35, sensor 78 generates a sensor signal that is received by a control circuit 112. Control circuit 112 is adapted to determine a specific physical properties and/or sensitometry associated with the particular media strip wound on core 12 based upon the signal from the sensor. In one embodiment, control circuit 112 can comprise a micro-processor, micro-controller, programmable analog device or other circuit or system that can be programmed or otherwise adapted to perform this function in a dedicated manner and to provide information regarding the determined specific properties and/or sensitometry to a printer controller that governs printing operations. In other embodiments, control circuit 112 can comprise a general purpose control circuit that is used to govern a plurality of printer functions including but not limited to this purpose. For example, in certain embodiments a micro-processor, micro-controller or hardwired control circuit used to perform printer functions such as image processing, data communications and/or printing can also be used for this purpose.

Thus, a wide variation associated with the sensitizing and finishing of the media can be corrected, adjusted or otherwise controlled using information that is peculiarly associated with the parameters or characteristics of the media stored on core 12 for example, by applying a look up table (LUT) adjustment in the printing process. Accordingly, a benefit achieved is the ability for of the printer media supply 110 to determine information about the media wound on core 12 so that image quality parameters can be determined and used within the image chain portion of the printer apparatus' microprocessor to obtain the highest quality printed image. All of this is accomplished without the need to rotate the media material strip during the sensing operation, and without the need for an electronic memory to be associated with media assembly 20.

As illustrated in FIG. 10, the four notches 68, 70, 72 and 74 about core 12 are 90° apart, but this need not be the case to practice the invention. Nor need there be four notches. Notches 68 and 70 merely rotationally locate flange 16 and core 12, and may be omitted, along with locating tabs 64 and 66 if one would rather rely on the T-bar and notch pair 72 and 74 for this function.

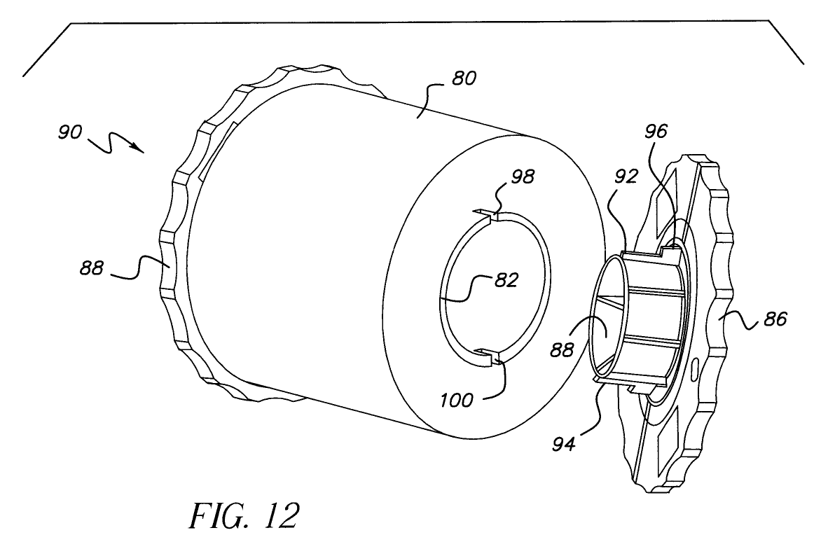

FIG. 12 shows another embodiment of a media assembly 20 wherein a media material strip 80 of media material wound on a cylindrical core 82. A pair of end flanges 86 and 88 fit into cylindrical core 82. For the purposes of describing this embodiment, the media material strip, the core, and the two end flanges form a media assembly that is generally referred to herein by reference numeral 90.

Flange 86 has an annular collar 92 with a plurality of tabs 94 that slide in respective slots on the annular surface of the collar. The tabs 94 have extensions 96 that align potential positions of notches 98 and 100 when flange 86 is mounted on the end of cylindrical core 82. In the illustrated embodiment, there are eight tabs spaced 45° apart about collar 92, but any suitable number of tabs and associated spacing may be selected.

Cylindrical core 82 has from zero to “n” notches cut during manufacture to align with tabs 94 on flange 86. The number and the locations of the notches are functions of the type of media material that is intended to be wound on cylindrical core 82. When flange 86 is mounted on the end of cylindrical core 82, the tab extensions 96 that do not align with a notch interfere with cylindrical core 82 so that the associated tab 94 is slid outwardly of flange 86 where they are detectable by suitable sensing means such as Fairchild Semiconductor's optical interrupter switch model QVE00112. Other tabs 94 that do align with a notch remain within the end flange 16.

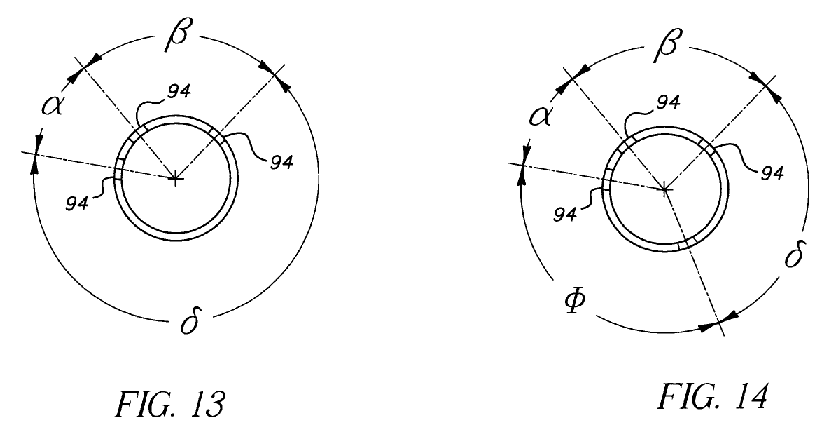

As shown in FIGS. 13 and 14, the spacing between tabs 94 need not be uniform. That is, FIG. 13 shows three tabs with spacing of α=25°, β=42°, and δ=293° there between. On the other hand, FIG. 14 shows four tabs with spacing of α=25°, β=42°, δ=65°, and φ=65° there between.

It will be appreciated that the above described printer apparatus and media assembly can be broadly used with any of a plurality of printer media including other forms of media upon which an image can be recorded such as films, fabrics and, generally, any other web media that can be located on a core 12. Similarly, other forms of media can include donor media of the type used in thermal printers.

The invention has been described in detail with particular reference to certain preferred embodiments thereof, but it will be understood that variations and modifications can be effected within the spirit and scope of the invention.

### PARTS LIST

10 media material strip
12 core
13 loose end of media material strip
14 tape
16 flange
18 flange
20 media assembly
22 printer apparatus
24 operator interface panel
26 print exit slot
28 tray
30 power switch
32 power connector
34 paper door
35 media supply system
36 alignment mark
38 alignment mark
40 pinch roller
42 central bore
43 flat surface of central bore
44 shaft
46 T-bar
48 flat
50 C-ring
52 spring
53 inner surface of flange
54 collar
56 slot
58 slot
60 arm
62 arm
64 locating tab
66 locating tab
68 notch
70 notch
72 notch
74 notch
75a bearing surface
75b bearing surface
76 post
78 sensor
80 media material strip
82 cylindrical core
86 flange
88 flange
90 media assembly
92 collar
94 tab
96 extension
98 notch
100 notch
112 control circuit

1. An apparatus comprising:
an elongated strip of media material having a parameter with a predetermined value;
a cylindrical core upon which the strip of the media material is spirally wound, said core having an end into which at least one notch is recessed such that the notch has a physical characteristic indicative of the predetermined parameter value of the wound strip.

2. A media assembly for identifying a predetermined parameter value of a strip of media material, said media assembly comprising:
a cylindrical core upon which a strip of the media material is spirally wound, said core having an end into which at least one notch is recessed such that the notch has a physical characteristic indicative of the predetermined parameter value of the wound strip; and
a flange on said core end adapted to detect the physical characteristic of the notch and to adapt a tactile feature that represents the parameter value of the wound strip.

3. A media assembly as set forth in claim 2, wherein the physical characteristic of the notch is its axial depth.

4. A media assembly as set forth in claim 2, wherein the flange includes a captured member that is urged into the notch.

5. A media assembly as set forth in claim 4, wherein:
the flange includes a captured member that is urged into the notch; and
the captured member has an element associated with the member so as to extend from the flange a distance inversely proportional to the depth of the notch so as to provide a detectable tactile feature that represents the parameter value of the wound strip.

6. A media assembly as set forth in claim 5, wherein the element is coaxial with the cylindrical core, whereby the tactile feature can be detected without the need to rotate the core during a sensing operation.

7. A media assembly as set forth in claim 4, wherein the captured member is a T-bar having an arm aligned with the notch.

8. A media assembly as set forth in claim 2, wherein the physical characteristic of the notch is its presence or absence.

9. A media assembly as set forth in claim 8, wherein the physical characteristic of the notch is its position about the end of the core relative to other notches.

10. A media assembly as set forth in claim 2, wherein the flange has tabs with extensions that align with potential positions of notches on the core when flange is mounted on the end of cylindrical core and wherein the core has at least one notch cut during manufacture to align with the tabs such that when the flange is mounted on the end of cylindrical core, the tab extensions that do not align with a notch interfere with cylindrical core so that the associated tab is slid outwardly of the flange and thus adapt the tactile feature of the tab in a manner that represents the parameter value of the wound strip.

11. A media supply system for a printer comprising:
a paper tray area adapted to receive a media assembly having a cylindrical core upon which a strip of a media material is spirally wound, said core having an end into which at least one notch is recessed such that the notch has a physical characteristic indicative of the predetermined parameter value of the wound strip; and a flange on said core end adapted to detect the physical characteristic of the notch and to adapt a tactile feature that represents the parameter value of the wound strip;
a sensor positioned proximate to the flange on said core end, said sensor being adapted to sense any adaptation of the tactile feature and to generate a sensor signal indicative of the current state of the tactile feature; and
a control circuit connected to the sensor and adapted to receive the sensor signal and to determine a parameter value of the wound strip based upon the sensor signal.

12. A media supply system of claim 11, wherein the flange includes a captured member that is urged into the notch; and the captured member has an element associated with the member so as to extend from the flange a distance inversely proportional to the depth of the notch so as to provide a detectable tactile feature that represents the parameter value of the wound strip.

13. A media supply system of claim 12, wherein the sensor is adapted to sense whether the element extends from the flange by a minimal depth and wherein the controller determines the parameter value of the wound strip based upon the sensor signal.

14. A media supply system of claim 12, wherein the core comprises a plurality of notches, each having a different axial depth, wherein the flange includes a captured member that can be urged into a selected one of the at least one notch; and the captured member has an element associated with the member so as to extend from the flange a distance inversely proportional to the depth of the notch so as to provide the detectable tactile feature that represents the parameter value of the wound strip.

15. A media supply of claim 12, wherein the sensor is adapted to sense the extent to which the element extends from the flange and wherein the controller determines the parameter value of the wound strip based upon the sensor signal.

16. A media supply system as set forth in claim 11, wherein the element is coaxial with the cylindrical core, whereby the tactile feature can be detected without the need to rotate the core during a sensing operation.

17. A media supply system as set forth in claim 11, wherein the captured member is a T-bar having an arm aligned with the notch.

18. A media supply system as set forth in claim 11, wherein the physical characteristic of the notch is its presence or absence.

19. A media supply system as set forth in claim 11, wherein the physical characteristic of the notch is its position about the end of the core relative to other notches.

20. A media supply system as set forth in claim 11, for use with a media supply assembly wherein the flange has tabs with extensions that align with potential positions of notches on the core when flange is mounted on the end of cylindrical core and wherein the core has at least one notch cut during manufacture to align with the tabs such that when the flange is mounted on the end of cylindrical core, the tab extensions that do not align with a notch interfere with cylindrical core so that the associated tab is slid outwardly of the flange and thus adapt the tactile feature of the tab in a manner that represents the parameter value of the wound strip, wherein said sensor is adapted to detect the outward sliding of the associated tab on the flange.
